(19) United States
(12) Patent Application Publication
(10) Pub. No.: US 2008/0246229 A1
(43) Pub. Date: Oct. 9, 2008

(54) Seal for Effecting a Sealing Between Parts Having Limited Mobility

(76) Inventor: Josef Ott, Gallenkappel (CH)

Correspondence Address: SUGHRUE MION, PLLC, 2100 PENNSYLVANIA AVENUE, N.W., SUITE 800, WASHINGTON, DC, 20037, US

(21) Appl. No.: 10/580,344

(22) PCT Filed: Nov. 19, 2004
(86) PCT No.: PCT/CH04/00700

§ 371 Date: Jan. 28, 2008

(30) Foreign Application Priority Data
Nov. 26, 2003 (CH) 2011/03

(51) Int. Cl. F16J 15/50

(52) U.S. Cl. 277/634

(57) ABSTRACT

The seal comprising a rubber-elastic body (5) that, in the middle, comprises a first through opening (6) for receiving a first part (3) and, in a peripheral edge (7), comprises a flange (8) for detachably fixing the body (5) inside an opening (23) of a second part (2). The first through opening (6) is made in a wall (9) that extends from a front side (17) toward a rear side (19) of the body (5) through a significantly larger second through opening (10) of the peripheral edge (7). The wall (9) and the first through opening (6) can move like an eye in the peripheral edge (7). The seal (1) is particularly suited for use in the automotive industry and, in particular, as a wiper sleeve.

The invention relates to a seal for effecting a sealing between parts having limited mobility, comprising an elastomeric body, which in the middle has a first through opening for receiving the one part and in a peripheral rim has a flange for detachably fastening the body in an opening of the other part.

Such seals are used, in particular, in motor vehicle construction. They serve, in particular, to seal a control lever or a wiper shaft. These seals are configured as sealing bellows or diaphragms and respectively have an enveloping wall which is made of a pliable or flexible material, in particular of rubber. The requirement placed upon such seals is that they should have a long life combined with adequate sealing effect, should be cheap to produce and easy to fit.

A rubber sleeve for sealing a wiper shaft is known. In this, a convex wall extends between the flange, which convex wall is provided in the middle with said first through opening for sealing of the wiper shaft. The problem herein exists that, upon a lateral movement of the wiper shaft, this stretches and is no longer sealtight. The production costs, moreover, are relatively high.

The object of the invention is to provide a seal of said type which is suitable, in particular, for sealing a wiper shaft and which is substantially cheaper to produce. Production should be able to be realized largely automatically in the injection molding process. Moreover, the seal should be visually attractive.

The object is achieved, in a seal of the generic type, by the fact that the first through opening is disposed in a wall which extends from a front side toward a rear side of the body through a substantially larger second through opening of the peripheral rim, such that said wall and the first through opening can be moved within the peripheral rim in the manner of an eye. In the seal according to the invention, said first through opening can be moved relatively far in the lateral direction without substantial forces being thereby exerted upon the peripheral rim or flange. The seal can be produced, moreover, in one piece in the injection molding process.

A visually particularly attractive configuration is possible when, according to a refinement of the invention, a collar is formed onto the outside of said wall, which collar undergrips with a rim the second through opening. On the outside, the seal thereby looks closed and esthetically particularly attractive.

A particularly cheap production is possible when, according to a refinement of the invention, said collar can be turned outward. The seal can then be produced with the collar turned out. Following the injection molding, the collar is turned inward, so that it undergrips the second through opening. Upon a lateral movement of the first through opening, the collar is displaced with respect to the flange, yet still remains in the second through opening and seals this against the outside.

Further advantageous features emerge from the dependent patent claims, the following description and the drawing.

An illustrative embodiment of the invention is explained in greater detail with reference to the drawing, in which:

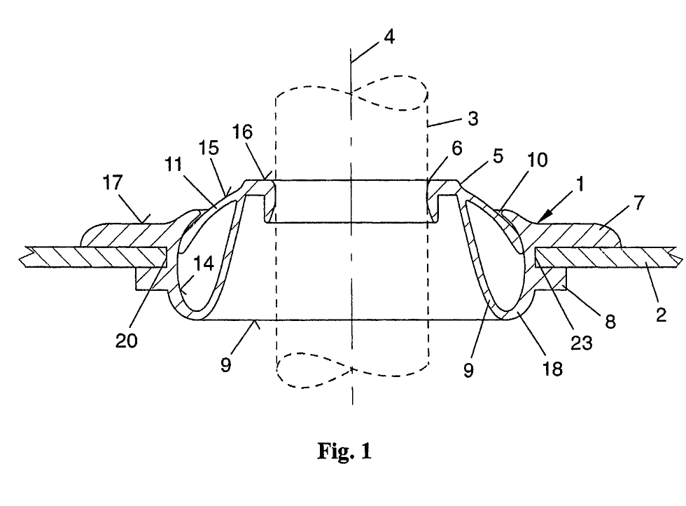

FIG. 1 shows a section through a fitted seal according to the invention,

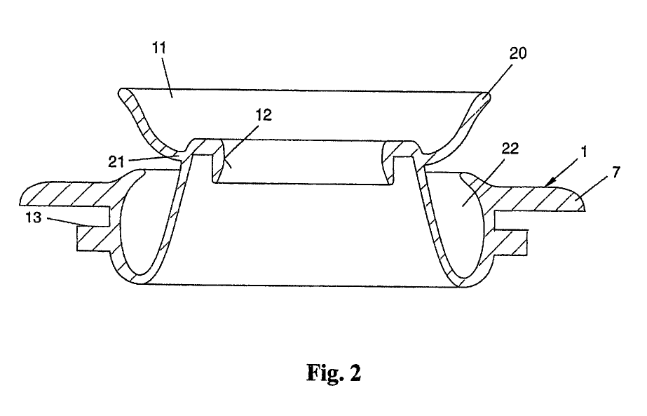

FIG. 2 shows a section through a seal according to the invention, as it is configured after having been produced in the injection molding process, following removal from the mold,

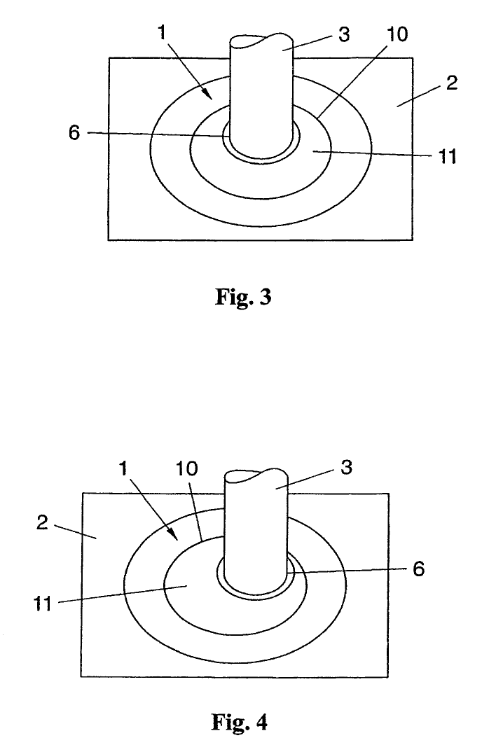

FIGS. 3+4 show in diagrammatic representation a view of a fitted seal for illustration of the lateral mobility of the first through opening, and

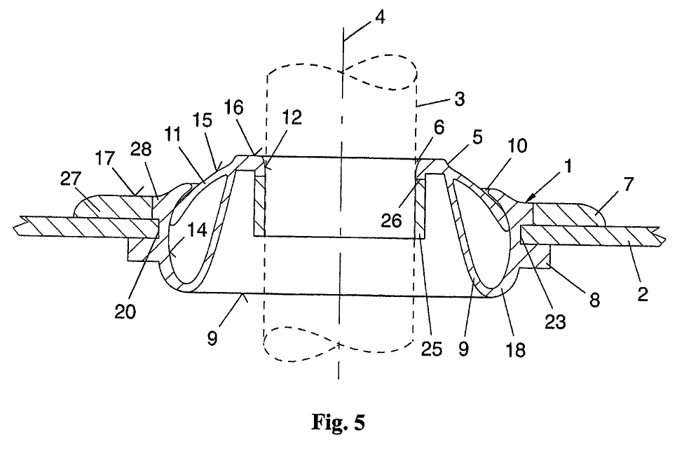

FIG. 5 shows in diagrammatic representation a section through a seal according to the invention according to one variant.

The seal 1 shown in FIG. 1 has an elastomeric body 5 and is inserted in an opening 23 of a housing 2 or housing part. A rim 20 of the opening 23 engages in a circumferential groove 13 (FIG. 2) of the body 2. Bearing against the housing 2 on the top side is a peripheral rim 7, which forms a sealing lip. Bearing against the housing 2 on the bottom side is a radially projecting flange 8, which is formed onto the body 5. The body 5 consists of an elastomeric thermoplastic plastic and is preferably produced in one piece in the injection molding process. The housing 2 can actually be formed by any relatively thin wall.

A relatively thin wall 9 has in the middle a through opening 6, which forms on the inside a sealing surface 12 (FIG. 2). The through opening 6 receives a shaft 3, for example the shaft of a windscreen wiper or the shaft of a gearshift lever. The through opening 6 can, however, also receive another part, for example a cable. The seal 1 seals the outer side 15 of the shaft 3 against the housing 2. In the through opening 6 there can alternatively be inserted a face seal ring (not shown here), which forms said sealing surface 12 and which can be made of a harder plastic.

As can be seen, the wall 9 extends from the rear side 19 of the housing 2 to the front side 17 and through a second through opening 10. This through opening 10 is formed by a circumferential lip 24, which, as can be seen, is angled inward and is formed onto the peripheral rim 7. In addition, onto the outside of the wall 9 there is formed, in the region of the opening 6, a collar 11, which forms a relatively thin wall and which is turned inward into an annular space 22 (FIG. 2). This collar 11 bears with a circumferential rim 20 elastically against an inner side 14 of the sealing lip 24.

The seal 1 is produced in the injection molding process such that, according to FIG. 2, the collar 11 is turned outward and is directed upward in the shape of a cup. The collar 11 is then turned inward into the position shown in FIG. 1, which can be done automatically. According to FIG. 2, the collar 11 possesses a circumferential attachment point 21 disposed close to a front end 16 (FIG. 1). This attachment point 21 is located at a distance from a bend 18 shown in FIG. 1, at which the wall 9 is deflected by about 180°. Since the wall 9 is relatively thin and flexible, lateral displacements in the region of the first through opening 6 are only slightly transmitted to the flange 8 and the peripheral rim 7. Likewise, movements on the housing 2 are only slightly transmitted to the sealing surface 12. The seal 1 is thus able to absorb relatively large relative movements between the shaft 3 and the housing 2 transversely to the axis 4 of the shaft 3. This also applies when a face seal ring made of a harder plastic is inserted in the through opening 6, as mentioned above. It is also vital that the opening 23 can be kept relatively small without any impairment of said mobility transversely to the axis 4.

According to FIGS. 3 and 4, the seal 1 has in plan view the appearance of an eye, the eye being formed by the collar 11 with the first through opening 6. The collar 11 with the through opening 6 can be moved about a point in similar fashion to an eye, whereupon the wall 9 is deformed. In FIG. 4, just such a lateral displacement of the shaft 3 is shown. In addition, tilting movements and superimposed transverse and tilting movements can also be absorbed. Other relative movements between the shaft 3 and the housing 2 can also be absorbed, however, without impairing the sealing effect, through a deformation of the wall 9. The seal 1 is thus adaptable like a conventional bellows, but looks substantially more compact from the outer side of the housing and calls for a smaller housing opening 23.

The seal 1′ shown in FIG. 5 differs from the seal 1 by an injected-on bearing bushing 25 and a likewise injected-on ring 27. The bearing bushing 5 consists of a harder plastic than the plastic adjoining a over a two-component composite 26 and forming a circumferential sealing surface 12′. The inward-extending bearing bushing 25, which is not visible from the outer side, ensures a particularly even force transmission and prevents a deformation of the sealing surface 12′ upon transverse and tilting movements of the axis 4.

The ring 27 likewise consists of a harder plastic than the plastic adjoining a two-component composite 28 and ensures a particularly secure connection of the peripheral rim 7′ to the housing 2.

### REFERENCE SYMBOL LIST

1. seal
2. housing
3. shaft
4. axis
5. body
6. first through opening
7. peripheral rim
8. flange
9. wall
10. second through opening
11. collar
12. sealing surface
13. groove
14. inner side
15. outer side
16. front end
17. front side
18. bend
19. rear side
20. rim
21. attachment point
22. annular duct
23. housing opening
24. lip
25. bearing bushing
26. two-component composite
27. ring
28. two-component composite

1. A seal for effecting a sealing between parts (2, 3) having limited mobility, comprising an elastomeric body (5), which in the middle has a first through opening (6) for receiving the one part (3) and in a peripheral rim (7) has a flange (8) for detachably fastening the body (5) in an opening (23) of the other part (2), characterized in that the first through opening (6) is disposed in a wall (9) which extends from a front side (17) toward a rear side (19) of the body (5) through a substantially larger second through opening (10) of the peripheral rim (7), such that said wall (9) and the first through opening (6) can be moved within the peripheral rim (7) in the manner of an eye.

2. The seal as claimed in claim 1, characterized in that a collar (11) is formed onto the outside of said wall (9), which collar undergrips with a rim (20) the second through opening (10).

3. The seal as claimed in claim 2, characterized in that the collar (11) undergrips an inwardly directed lip (24).

4. The seal as claimed in claim 2 or 3, characterized in that the collar (11) can be turned outward.

5. The seal as claimed in one of claims 2 to 4, characterized in that the collar (11) is formed onto the wall (9) close to the first through opening (6).

6. The seal as claimed in claim 5, characterized in that the collar (11) is turned outward in the shape of a cup.

7. The seal as claimed in one of claims 1 to 6, characterized in that the first through opening (6) is located above the second through opening (10).

8. The seal as claimed in one of claims 1 to 7, characterized in that it is intended for a motor vehicle.

9. The seal as claimed in one of claims 1 to 8, characterized in that it is a wiper sleeve.

10. The seal as claimed in one of claims 1 to 9, characterized in that a face seal ring is inserted in the first through opening (6).

11. The seal as claimed in one of claims 1 to 10, characterized in that a bearing bushing (25) made of a harder plastic is formed on.

12. The seal as claimed in claim 11, characterized in that the bearing bushing (25) is formed on in the region of a sealing surface (12′) formed by a softer plastic.

13. The seal as claimed in one of claims 1 to 12, characterized in that a ring (27) made of harder plastic is formed onto the peripheral rim (7′).
